(19) United States
(12) Patent Application Publication
(10) Pub. No.: US 2012/0001484 A1
(43) Pub. Date: Jan. 5, 2012

(54) AUTOMOTIVE BATTERY OVER-DISCHARGE PREVENTION DEVICE

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/875,094

(22) Filed: Sep. 2, 2010

(30) Foreign Application Priority Data
Jul. 2, 2010 (TW) 99121950

(51) Int. Cl. H02H 7/18; B60L 1/00

(52) U.S. Cl. 307/10.7

(57) ABSTRACT

An automotive battery over-discharge prevention device includes a controlling module, a monitoring module connected to an automotive battery supplying power to an auxiliary device and a starting device, and a switch connecting the automotive battery to the auxiliary device. The monitoring module is configured for obtaining the voltage of the automotive battery, and converting the obtained voltage to a voltage signal. The controlling module is connected to the switch and the monitoring module. The controlling module stores a threshold voltage which is greater than an operation voltage at which the automotive battery is capable of operating the starting device. The controlling module is configured for comparing the voltage output from the monitoring module with the threshold voltage. If the voltage is smaller than the threshold voltage, the controlling module opens the switch. Otherwise, the controlling module closes the switch.

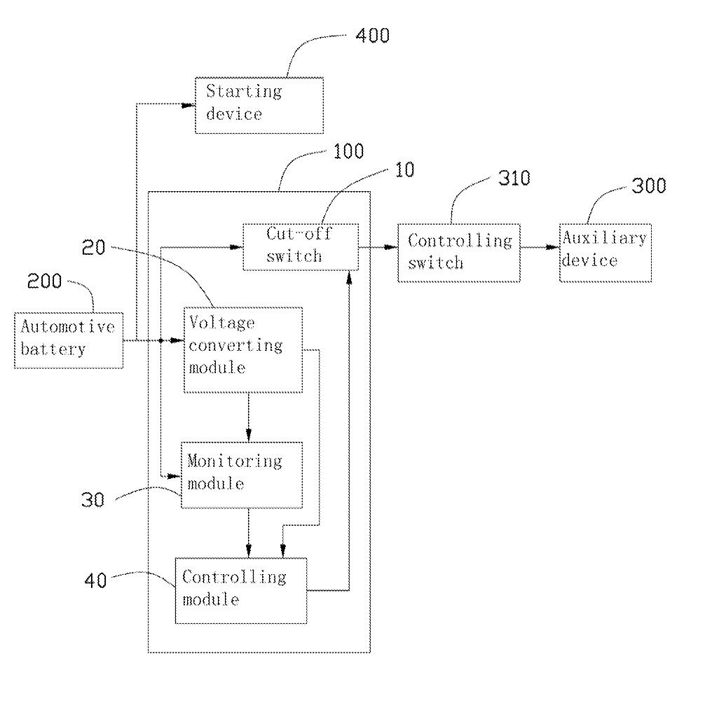

### BACKGROUND

1. Technical Field

The present disclosure relates to a device which prevents over-discharging an automotive battery.

2. Description of Related Art

It is a common occurrence for people to forget to turn off their headlights and run their car battery down. Particularly when they use their headlights during the daytime as is required on certain roadways. This is inconvenient to the driver.

What is needed, therefore, is an automotive battery over-discharge prevention device to overcome the above-described problem.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

The drawing is a block diagram of an automotive battery over-discharge prevention device employed in a vehicle according to an exemplary embodiment.

### DETAILED DESCRIPTION

Embodiments of the present disclosure will now be described in detail below, with reference to the accompanying drawings.

Referring to the drawing, an automotive battery over-discharge prevention device 100 is employed in a vehicle. The device 100 is used for preventing over-discharge of an automotive battery 200, leaving enough reserve power to operate a starter motor of the vehicle. The automotive battery 200 supplies power to an auxiliary device 300 and a starting device 400. In the present embodiment, the auxiliary device 300 is a headlight of a vehicle (not shown). The starting device 400 is a starter motor of the vehicle. The device 100 is connected between the automotive battery 200 and the auxiliary device 300 for preventing the automotive battery 200 from being run down by the auxiliary device 300. In the present embodiment, the device 100 is connected to the auxiliary device 300 via a controlling switch 310 which is used for cutting off the auxiliary device 300.

The device 100 includes a cut-off switch 10, a voltage converting module 20, a monitoring module 30, and a controlling module 40.

The cut-off switch 10 connects the automotive battery 200 to the controlling switch 310. The cut-off switch 10 is an electronic switch. In the present embodiment, the cut-off switch 10 is a normally closed switch. The cut-off switch 10 remains closed until voltage of the automotive battery 200 drops to a predetermined value.

The voltage converting module 20 is electrically connected to the automotive battery 200, the monitoring module 30, and the controlling module 40. The voltage converting module 20 is used for obtaining a voltage from the automotive battery 200, and dividing the voltage to two rated voltages for supplying power to the monitoring module 30 and the controlling module 40. In the present embodiment, the voltage converting module 20 is a resistor voltage-divider. The voltage converting module 20 outputs two rated voltages to the monitoring module 30 and the controlling module 40. In other embodiments, the monitoring module 30 and the controlling module 40 can be powered by a dedicated power supply, such as a dry cell battery, thus, the voltage converting module 20 can be omitted.

The monitoring module 30 is electrically connected to the automotive battery 200. The monitoring module 30 is configured for obtaining the voltage of the automotive battery 200, and converting the voltage to a voltage signal to the controlling module 40. In the present embodiment, the voltage of the voltage signal is lower than that of the automotive battery 200 so it can be processed by the controlling module 40. The current voltage of the voltage signal is defined as V. When the automotive battery 200 is capable of operating the starting device 400, the corresponding voltage of the voltage signal is V1.

The controlling module 40 is electrically connected to the monitoring module 30. In the present embodiment, the controlling module 40 is a comparator. A threshold voltage Vo greater than the voltage V1 is preset in the controlling module 40. The monitoring module 30 is configured for comparing the current voltage V with the threshold voltage Vo. If the current voltage V is smaller than the threshold voltage Vo, the controlling module 40 sends an turn-off signal to the cut-off switch 10, as a result, the cut-off switch 10 is opened and the automotive battery 200 will not be further discharged. If current voltage V is greater than or equal to the threshold voltage Vo, the controlling module 40 sends a turn-on signal to the cut-off switch 10, as a result, the cut-off switch 10 is closed and the automotive battery 200 powers the auxiliary device 300 until the current voltage V is less than the threshold voltage Vo. In the present embodiment, the controlling module 40 cuts off the open signal to the controlling switch 310.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. An over-discharge prevention device for an automotive battery, the automotive battery supplying power to an auxiliary device and a starting device, the automotive battery over-discharge prevention device comprising:
a cut-off switch electrically connecting the automotive battery to the auxiliary device;
a monitoring module electrically connected to the automotive battery, and configured for obtaining a current voltage of the automotive battery and converting the obtained current voltage to a voltage signal;
a controlling module electrically connected to the monitoring module and the cut-off switch, the controlling module presetting a threshold voltage, wherein threshold voltage is greater than an operation voltage of the automotive battery at which the automotive battery is capable of operating the starting device, the controlling module is configured to received the voltage signal from the monitoring module and compare the current voltage with the threshold voltage, the controlling module is also configured to control the cut-off switch to turn the auxiliary device on upon a condition that the current voltage is greater than or equal to the threshold voltage, and to control the cut-off switch to turn the auxiliary device off upon a condition that the current voltage is smaller than the threshold voltage.

2. The over-discharge prevention device as claimed in claim 1, wherein the starting device is a starter of a vehicle, the auxiliary device is a headlight of the vehicle.

3. The over-discharge prevention device as claimed in claim 1, further comprising a voltage converting module electrically connected to the automotive battery, the monitoring module, and the controlling module, the voltage converting module configured for obtaining a voltage from the automotive battery, and dividing the voltage to two rated voltages for supplying power to the monitoring module and the controlling module.

4. The over-discharge prevention device as claimed in claim 3, wherein the voltage converting module is a resistor voltage-divider.

5. The over-discharge prevention device as claimed in claim 1, wherein the cut-off switch is an electronic switch.

6. The over-discharge prevention device as claimed in claim 1, wherein the cut-off switch is a normally closed switch.

7. The over-discharge prevention device as claimed in claim 1, wherein the controlling module is a comparator.

8. An over-discharge prevention device for an automotive battery, the automotive battery supplying power to an auxiliary device and a starting device, the automotive battery over-discharge prevention device comprising:
a cut-off switch electrically connecting the automotive battery to the auxiliary device;
a monitoring module connected to the automotive battery, and configured for detecting a current voltage of the automotive battery and outputting a voltage signal corresponding to the current voltage of the automotive battery;
a controlling module connected to the monitoring module and the cut-off switch and presetting a threshold voltage, the controlling module configured for comparing the threshold voltage with the current voltage, wherein the threshold voltage is greater than an operating voltage at which the automotive battery is capable of operating the starting device, if the current voltage is smaller than the threshold voltage, the controlling module controls the cut-off switch to turn off, if the current voltage is greater than or equal to the threshold voltage, the controlling module controls the cut-off switch to turn on.

9. The over-discharge prevention device as claimed in claim 8, wherein the auxiliary device is a headlight of a vehicle, the starting device is a starter of a vehicle.

10. The over-discharge prevention device as claimed in claim 8, further comprising a voltage converting module electrically connected to the automotive battery, the monitoring module, and the controlling module, the voltage converting module configured for obtaining a voltage from the automotive battery, and dividing the voltage to two rated voltages for supplying power to the monitoring module and the controlling module.

11. The over-discharge prevention device as claimed in claim 10, wherein the voltage converting module is a resistor voltage-divider.

12. The over-discharge prevention device as claimed in claim 8, wherein the cut-off switch is an electronic switch.

13. The over-discharge prevention device as claimed in claim 8, wherein the cut-off switch is a normally closed switch.

14. The over-discharge prevention device as claimed in claim 8, wherein the controlling module is a comparator.
